(19) United States
(12) Patent Application Publication
(10) Pub. No.: US 2026/0095810 A1
(43) Pub. Date: Apr. 2, 2026

(54) COMMUNICATION APPARATUS, CONTROL METHOD, AND COMPUTER-READABLE STORAGE MEDIUM

(71) Applicant: CANON KABUSHIKI KAISHA, Tokyo (JP)

(72) Inventor: Yuki Yoshikawa, Kanagawa (JP)

(21) Appl. No.: 19/413,096

(22) Filed: Dec. 9, 2025

Related U.S. Application Data
(63) Continuation of application No. PCT/JP2024/021790, filed on Jun. 17, 2024.

(30) Foreign Application Priority Data
Jun. 20, 2023 (JP) 2023-101183

(51) Int. Cl. H04W 28/082; H04W 84/12

(52) U.S. Cl. CPC H04W 28/082; H04W 84/12

(57) ABSTRACT

A communication apparatus capable of executing communication complying with an IEEE 802.11 series standard by establishing a plurality of radio links with a partner apparatus communicates a radio frame including information for requesting not to permit transmission of all types of traffic in some radio links among the plurality of radio links, with the partner apparatus in other radio links among the plurality of radio links, and controls, based on the radio frame, to set an incommunicable state while maintaining the some radio links by not permitting transmission of all the types of traffic in the some radio links.

### CROSS-REFERENCE TO RELATED APPLICATIONS

This application is a Continuation of International Patent Application No. PCT/JP2024/021790, filed June 17, 2024, which claims the benefit of Japanese Patent Application No. 2023-101183, filed June 20, 2023, both of which are hereby incorporated by reference herein in their entirety.

### BACKGROUND

### Field of the Technology

The present disclosure relates to an operation technique of a communication apparatus capable of using a plurality of links.

### DESCRIPTION OF THE RELATED ART

In response to an increasing demand for communication, wireless communication techniques such as wireless LAN (Local Area Network) have been developed. As a major communication standard of the wireless LAN, the IEEE (Institute of Electrical and Electronics Engineers) 802.11 standard series is known. The IEEE 802.11 standard series includes standards such as IEEE 802.11a/b/g/n/ac/ax/be (see PTL 1). The IEEE 802.11be standard has examined multi-link communication in which one access point (AP) establishes a plurality of radio links with one station (STA) and performs communication using the plurality of radio links simultaneously. A communication apparatus supporting multi-link communication is called a Multi-Link Device (MLD). Note that an MLD functioning as an AP is called an AP MLD and an MLD functioning as an STA is called an STA MLD if it is necessary to particularly discriminate them.

PTL 1: Japanese Patent Laid-Open No. 2021-052638

It is possible to improve throughput of communication or reduce a delay by using multi-link communication. On the other hand, when there are a plurality of radio links configured to enable communication, power consumption can increase.

### SUMMARY

The present disclosure provides a technique for improving power efficiency in communication by a communication apparatus capable of using a plurality of radio links.

A communication apparatus according to one aspect of the present disclosure is a communication apparatus capable of executing communication complying with an IEEE 802.11 series standard by establishing a plurality of radio links with a partner apparatus, comprising: a communication unit configured to communicate a radio frame including information for requesting not to permit transmission of all types of traffic in some radio links among the plurality of radio links, with the partner apparatus in other radio links among the plurality of radio links; and a control unit configured to control, based on the radio frame, to set an incommunicable state while maintaining the some radio links by not permitting transmission of all the types of traffic in the some radio links.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure and, together with the description, serve to explain principles of the disclosed technique.

FIG. 1 is a view showing an example of the configuration of a network.

FIG. 2 is a block diagram showing the hardware arrangement of a communication apparatus (AP or STA).

FIG. 3 is a block diagram showing an example of the functional arrangement of the communication apparatus (AP or STA).

FIG. 4 is a sequence chart showing a first example of a message sequence between the communication apparatuses.

FIG. 5 is a view showing an example of the format of a TID-To-Link Mapping Request or Response frame.

FIG. 6 is a flowchart illustrating an example of the procedure of processing for controlling the number of communicable links after connection, which is executed in a communication apparatus on a frame transmission side.

FIG. 7 is a flowchart illustrating an example of the procedure of processing for controlling the number of communicable links after connection, which is executed in a communication apparatus on a frame reception side.

FIG. 8 is a sequence chart showing a second example of the message sequence between the communication apparatuses.

FIG. 9 is a view showing an example of the format of a frame including a TID-To-Link Mapping Element.

FIG. 10 is a sequence chart showing a third example of the message sequence between the communication apparatuses.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Configuration of Wireless Communication System

FIG. 1 shows an example of the configuration of a wireless communication system according to this embodiment. The wireless communication system is a wireless LAN (Local Area Network) system, and includes an access point (AP 100) and a station (STA 101). The AP 100 creates a network 110. The STA 101 is located within the communicable range of the network 110, and joins the network 110 by establishing connection to the AP 100. Note that a term "AP 100 and STA 101" indicates both or one of the AP 100 and the STA 101 unless otherwise specified.

Each of the AP 100 and the STA 101 is a wireless communication apparatus that can execute wireless communication complying with the IEEE 802.11be standard (to be referred to as the "be standard" hereinafter). Note that IEEE is an abbreviation for Institute of Electrical and Electronics Engineers. The AP 100 and the STA 101 can perform communication using frequency bands such as the 2.4-GHz band, 3.6-GHz band, 5-GHz band, and 6-GHz band. In addition, the AP 100 and the STA 101 can perform communication also in the 45-GHz band and 70-GHz band called the millimeter wave bands. Note that the frequency bands usable by each communication apparatus are not limited to these. For example, a different frequency band like the Sub-1 GHz band may be used. Each communication apparatus can perform communication using bandwidths of 20 MHz, 40 MHz, 80 MHz, 170 MHz, 320 MHz, 540 MHz, 640 MHz, 1080 MHz, and 2170 MHz in the above-described frequency bands. The bandwidths usable by each communication apparatus are not limited to these, and other bandwidths of, for example, 240 MHz and 4 MHz may be used. This embodiment will describe a communication control technique applied in the be standard. However, the communication control technique may be applied in, for example, another IEEE 802.11 series standard defined after the be standard.

In addition to the be standard, each of the AP 100 and the STA 101 may support another standard. For example, each of the AP 100 and the STA 101 can support at least one of the IEEE 802.11a/b/g/n/ac/ax/bn standards. In addition to a wireless communication function complying with the IEEE 802.11 series standards, each of the AP 100 and the STA 101 may have a wireless communication function complying with another communication standard such as Bluetooth^{®}, NFC, UWB, ZigBee, or MBOA. Note that UWB is an abbreviation for Ultra Wide Band, and MBOA is an abbreviation for Multi Band OFDM Alliance. Furthermore, NFC is an abbreviation for Near Field Communication. UWB includes wireless USB, wireless 1394, and WiNET. Each of the AP 100 and the STA 101 may support communication standards of wired communication such as a wired LAN. The AP 100 can be, for example, a wireless LAN router, a personal computer (PC), or the like, but is not limited to these. The AP 100 may be an information processing apparatus such as a radio chip capable of executing wireless communication complying with the be standard. The STA 101 can be, for example, a camera, a tablet, a smartphone, a PC, a portable telephone, a video camera, or the like, but is not limited to these. The STA 101 may be an information processing apparatus such as a radio chip capable of executing wireless communication complying with the be standard. For the sake of descriptive simplicity, FIG. 1 shows only one AP and one STA. However, there may exist a plurality of APs and a plurality of STAs, and the arrangement of them is not limited to the pattern shown in FIG. 1.

The AP 100 and the STA 101 can execute Multi-User (MU) communication in which signals of a plurality of users are multiplexed by using Orthogonal Frequency Division Multiple Access (OFDMA) complying with the be standard. In OFDMA communication, Resource Units (RUs) formed by some of a number of orthogonal subcarriers arranged over a usable frequency band are defined. Then, the RUs that do not overlap each other are allocated to respective APs/STAs, and each AP/STA can perform communication using the allocated RU. Thus, each AP/STA can simultaneously communicate with a plurality of other APs/STAs in the defined band. For example, an AP can simultaneously communicate with a plurality of STAs by allocating different RUs to the plurality of STAs. For example, a plurality of APs can transmit data to one STA using different RUs.

The AP 100 and the STA 101 can be configured to execute Multiple-Input and Multiple-Output (MIMO) communication. In this case, each of the AP 100 and the STA 101 includes a plurality of antennas. In MIMO, by using the transmission path characteristics between the plurality of antennas on the transmission side and the plurality of antennas on the reception side, a plurality of data streams are simultaneously transmitted/received in the same frequency channel and the same time section. For example, radio signals corresponding to the different data streams are transmitted in the same frequency channel from the plurality of antennas on the transmission side, and the plurality of antennas on the reception side receive a radio signal obtained by mixing the radio signals. Then, the reception-side communication apparatus separates and extracts the plurality of transmitted data streams from the radio signal based on the transmission path characteristics between the transmission antennas and the reception antennas. Note that this is merely an example, and for example, a plurality of signals obtained by performing primary modulation for the plurality of data streams may undergo weighted addition based on the above-described transmission path characteristics, thereby forming a radio signal to be transmitted by each of the plurality of transmission antennas. The AP 100 and the STA 101 can perform communication with higher frequency use efficiency by executing MIMO communication.

This embodiment assumes that each of the AP 100 and the STA 101 is a Multi-Link Device (MLD) capable of executing multi-link communication of performing communication by establishing a plurality of radio links. The AP 100 and the STA 101 execute communication by establishing a plurality of radio links that use different frequency channels. For example, the STA 101 can establish, with the AP 100, a first link 120 that uses the 5-GHz band and a second link 121 that uses the 6-GHz band. However, this is merely an example, and three or more links may be established, or a combination of frequency bands other than the combination of the 5-GHz band and the 6-GHz band may be used. For example, in addition to the first link 120 and the second link 121, a third link may be established between the AP 100 and the STA 101. Furthermore, frequency channels used in the plurality of radio links may be a plurality of different frequency channels included in the same frequency band. For example, ch 36 in the 5-GHz band may be used in the first link 120 and ch 161 in the 5-GHz band may be used in the second link 121. Note that "ch" means "channel". Note that when three or more radio links are formed, links that use the same frequency band and links that use different frequency bands may be mixed. For example, in addition to the first link 120 that uses ch 5 in the 6-GHz band and the second link 121 that uses ch 213 in the 6-GHz band, the third link that uses ch 6 in the 2.4-GHz band can be established. When a plurality of connections using different frequency channels are established, even if sufficient communication quality cannot be obtained due to congestion in any of the frequency channels, it is possible to perform communication with good communication quality using another frequency channel. This can suppress reduction in throughput in communication and an increase in communication delay.

Note that each radio link is assigned with an identifier (Link ID) for identifying the link. For example, when the first link 120 in the 5-GHz band and the second link 121 in the 6-GHz band are formed between the AP 100 and the STA 101, the Link ID = 1 can be assigned to the first link 120 and the Link ID = 2 can be assigned to the second link. Note that these values are merely examples, and other values can be assigned. The link ID may be assigned to each network in which the radio link is established. That is, the Link ID = 1 may be assigned to a network created by the AP 100 in the 5-GHz band in which the first link 120 is established. In this case, even if another STA establishes a radio link with the AP 100 via the network in the 5-GHz band, the Link ID = 1 is used in the link. That is, in one network, a different Link ID may be assigned to each STA or a common Link ID may be assigned to a plurality of STAs.

In this embodiment, as described above, it is possible to use multi-link communication in which a plurality of radio links are established between the AP 100 and the STA 101. If the plurality of radio links are always usable, the power consumption of the AP 100 and the STA 101 increases. Especially, there is a definition concerning the power saving function of the STA 101 in the existing standard but there is no specific definition concerning the AP 100. The power consumption can be suppressed by increasing/decreasing the number of radio links between the AP 100 and the STA 101. However, every time a link is added, a procedure such as key exchange is necessary, and the overhead due to control communication becomes large. This embodiment provides a mechanism for suppressing power consumption without increasing the overhead.

### Arrangement of AP and STA

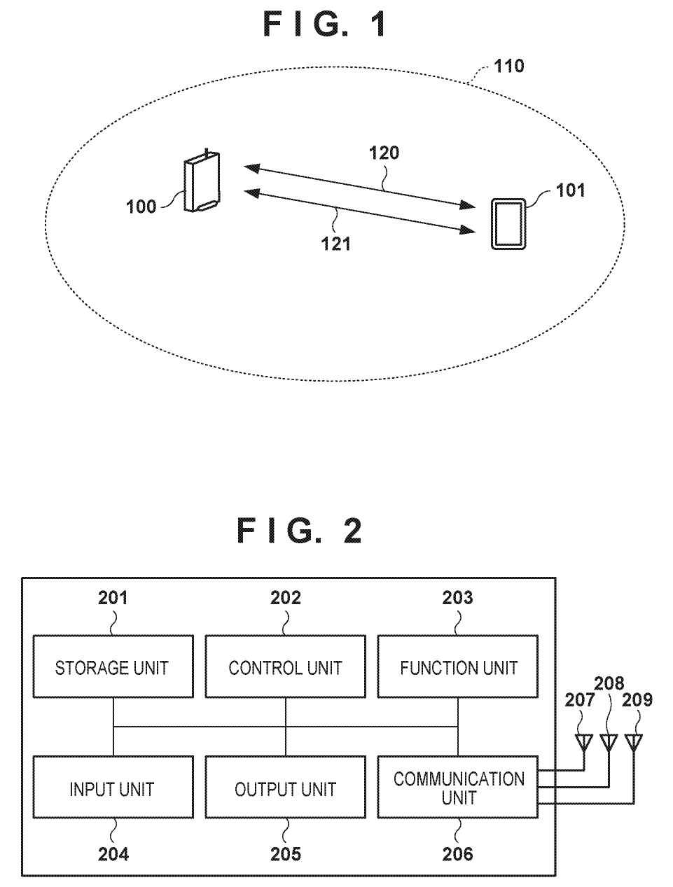

FIG. 2 shows an example of the hardware arrangement of each of the AP 100 and STA 101. Each of the AP 100 and STA 101 includes a storage unit 201, a control unit 202, a function unit 203, an input unit 204, an output unit 205, a communication unit 206, and antennas 207 to 209. Note that these are merely examples, each of the AP 100 and the STA 101 may have a further component not shown in FIG. 2, and some or all of the components shown in FIG. 2 may be replaced by other components having the same functions.

The storage unit 201 includes one or more memories such as a ROM and a RAM. The storage unit 201 stores computer programs for performing various operations to be described later, and various kinds of information such as communication parameters for wireless communication. Note that ROM is an abbreviation for Read Only Memory, and RAM is an abbreviation for Random Access Memory. Note that other than the memories such as a ROM and a RAM, the storage unit 201 may include a storage medium such as a flexible disk, a hard disk, an optical disk, a magnetooptical disk, a CD-ROM, a CD-R, a magnetic tape, a nonvolatile memory card, or a DVD. The storage unit 201 may include a plurality of storage media such as memories.

The control unit 202 includes, for example, one or more processors such as a CPU and an MPU. Note that CPU is an abbreviation for Central Processing Unit and MPU is an abbreviation for Micro Processing Unit. The control unit 202 controls the whole apparatus (AP 100 or STA 101) by executing the computer programs stored in the storage unit 201. Note that the control unit 202 may control the whole apparatus by cooperation of the computer programs stored in the storage unit 201 and an operating system. In addition, the control unit 202 generates data and signals (radio frames) to be transmitted in communication with another communication apparatus. In addition, the control unit 202 may include a plurality of processors such as a multi-core processor, and controls the whole AP 100 or STA 101 by the plurality of processors.

In addition, the control unit 202 controls the function unit 203 to execute wireless communication and predetermined processing such as image capturing, printing, or projection. The function unit 203 includes hardware used by the AP 100 or STA 101 to execute predetermined processing. If the apparatus (AP 100 or STA 101) is a printer, the function unit 203 serves as a printing apparatus and, for example, prints image data acquired via the communication unit 206. If the apparatus is a scanner, the function unit 203 serves as a reading apparatus, and outputs image data generated by scanning to, for example, the outside via the communication unit 206. If the apparatus is a camera, the function unit 203 includes an image sensor and a lens, and outputs image data captured by the camera to, for example, the outside via the communication unit 206.

The input unit 204 includes, for example, a touch panel, hardware keys, and buttons, and accepts various kinds of operations from the user. The output unit 205 includes a display and a loudspeaker, and performs various kinds of outputs to the user. In this example, the output by the output unit 205 can include screen display output on the display and audio output by the loudspeaker. In addition, the output unit 205 may include a vibrator, and may output information by vibration output. Note that both the input unit 204 and the output unit 205 may be implemented by one module, like a touch panel display. Furthermore, each of the input unit 204 and the output unit 205 may be incorporated in the apparatus (AP 100 or STA 101), or may be implemented by an external input/output device. In this case, the apparatus includes an input/output interface for connection to the input/output device.

The communication unit 206 executes control for performing wireless communication complying with the be standard. In addition to the be standard, the communication unit 206 can control wireless communication complying with another IEEE 802.11 series standard or control wired communication by a wired LAN or the like. The communication unit 206 controls the antennas 207 to 209 to transmit/receive signals for wireless communication generated by the control unit 202. For example, the AP 100 communicates data such as image data, document data, or video data with the STA 101 via the communication unit 206. Note that if the AP 100 and the STA 101 support the NFC standard or Bluetooth standard in addition to the be standard, the communication unit 206 may control wireless communication complying with these communication standards. If the AP 100 and the STA 101 can execute wireless communication complying with a plurality of communication standards, communication units and antennas supporting the respective communication standards can be individually prepared.

The antennas 207 to 209 are, for example, antennas configured to detect and emit radio waves in the 2.4-GHz band, the 5-GHz band, and the 6-GHz band, respectively. Note that the antennas 207 to 209 may be configured to execute communication in the same frequency band. In this case, the antennas 207 to 209 can be, for example, a multiband antenna capable of executing communications in a plurality of frequency bands. This embodiment describes an example in which each of the AP 100 and the STA 101 includes three antennas (antennas 207 to 209), but two or less antennas or four or more antennas may be used. Note that if each of the AP 100 and the STA 101 includes a plurality of antennas, it may include communication units 206 respectively corresponding to the antennas. Note that each of the antennas 207 to 209 may be prepared separately from the communication unit 206 or may be formed as one module combined with the communication unit 206.

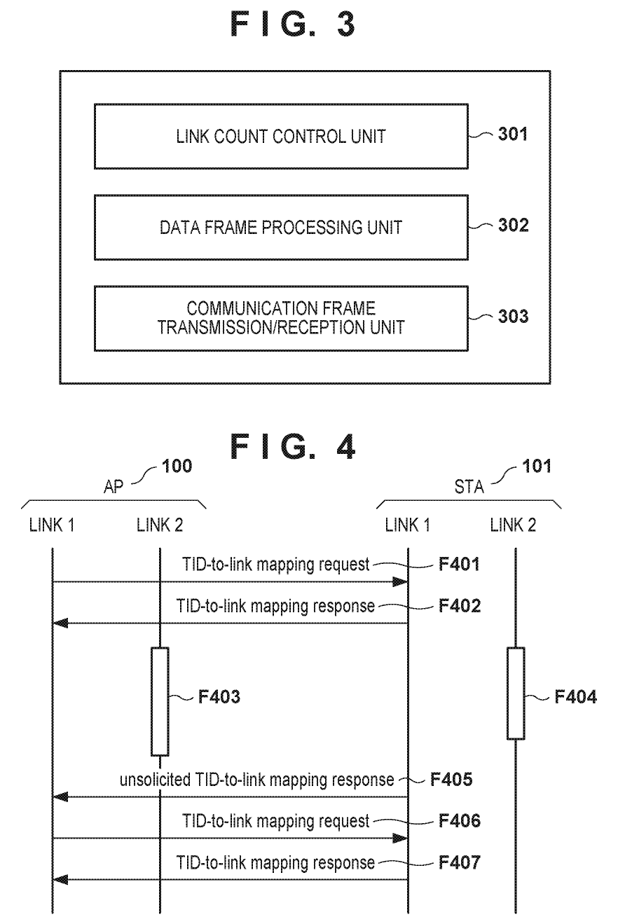

FIG. 3 is a block diagram showing an example of the functional arrangement of each of the AP 100 and the STA 101. Each of the AP 100 and the STA 101 includes, as the functional arrangement, for example, a link count control unit 301, a data frame processing unit 302, and a communication frame transmission/reception unit 303. These functions can be implemented when, for example, the control unit 202 executes programs stored in the storage unit 201 of each of the AP 100 and the STA 101. This is merely an example, and dedicated hardware for implementing each function may be prepared.

The link count control unit 301 controls the number of radio links that allow communication between the AP 100 and the STA 101 based on information such as the presence/absence of data to be transmitted/received, the amount of the data, and a data transmission/reception frequency. When restricting the number of links, the link count control unit 301 controls a link associated with a specific Link ID to be set in an incommunicable state. The data frame processing unit 302 executes predetermined processing for a data frame to be transmitted or a received data frame. The data frame processing unit 302 generates a data frame (radio frame) including data to be transmitted, and upon receiving a data frame destined for the self-apparatus, extracts data by processing the data frame. Note that the data frame processing unit 302 acquires information such as the presence/absence of data to be transmitted/received, the amount of the data, and a data transmission/reception frequency by executing the above-described processing, and provides the information to the link count control unit 301. The link count control unit 301 executes the above-described processing of controlling the number of links based on the provided information. The communication frame transmission/reception unit 303 transmits/receives a control frame, a management frame, and a data frame. Note that the control frame includes, for example, a Trigger frame, an RTS (Request To Send) frame, and a CTS (Clear To Send) frame. The management frame includes a Beacon frame, an Association frame, and a BA (Block ACK) frame.

### Procedure of Processing

Some examples of the procedure of the above-described processing executed by the AP 100 and the STA 101 will be described.

### Processing Example 1

FIG. 4 shows an example of the procedure of communication according to this processing example. In this processing example, the AP 100 and the STA 101 establish two radio links of the Link IDs = 1 and 2, and controls the number of communicable links using a TID-To-Link Mapping frame. The radio link of the Link ID = 1 will be referred to as link 1 hereinafter, and the radio link of the Link ID = 2 will be referred to as link 2 hereinafter. In this processing example, for example, the AP 100 requests the STA 101 not to use some links, thereby setting the link designated by the request in an unusable state (Disable state). As an example, for this request, a Traffic Identifier (TID) is used. To designate the type of data to be communicated in each link in multi-link communication, a TID is used. By not assigning this TID to a given link, it is possible to set the Disable state in which the link is not used for communication. In the example shown in FIG. 4, the AP 100 requests the STA 101 not to assign a TID to a link, and the STA 101 permits it, thereby setting the established link in the Disable state. After that, the STA 101 requests to assign a TID to the link in the Disable state, thereby setting the link in a usable state (Enable state).

In FIG. 4, the AP 100 transmits, to the STA 101, a TID-To-Link Mapping Request frame to request to set link 2 in the Disable state (F401). At this time, if the AP 100 cannot simultaneously execute transmission and reception in the plurality of links, a primary link as a main link for data transmission and a non-primary link as a subordinate link are defined. The AP 100 sets, for example, only the non-primary link in the Disable state. Note that the AP that cannot simultaneously execute transmission/reception in the plurality of links is called a Non-Simultaneous Transmission and Reception (NSTR) AP MLD.

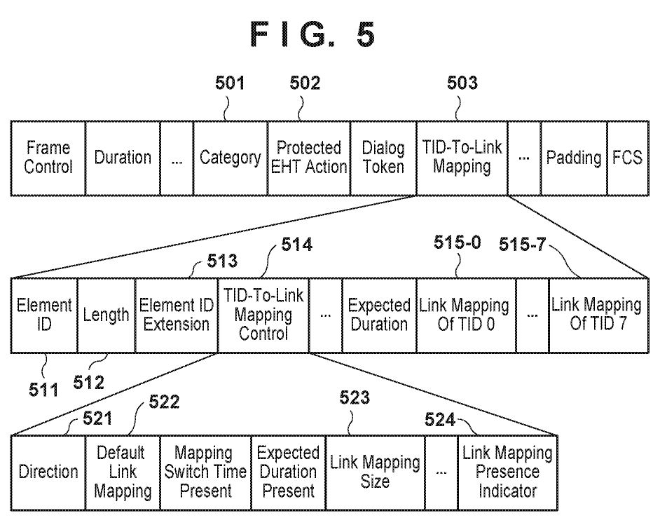

An example of the TID-To-Link Mapping Request frame transmitted by the AP 100 will now be described with reference to FIG. 5. The TID-To-Link Mapping Request frame is a kind of Action frame. This radio frame includes, for example, a Category field 501, a Protected EHT Action field 502, and a TID-To-Link Mapping field 503.

The Category field 501 stores a value indicating the type of the Action frame. In this embodiment, when a value "37" is stored in the Category field 501, it is indicated that this frame is a Protected EHT Action frame. The Protected EHT Action field 502 stores a value indicating the type of the Protected EHT Action frame. In this embodiment, when a value "0" is stored in this field, it is indicated that this frame is a TID-To-Link Mapping Request frame. The TID-To-Link Mapping field 503 is a field indicating TID-To-Link Mapping information using a TID-To-Link Mapping Element. This field need not be included in this frame, or a plurality of fields may be included. For example, the TID-To-Link Mapping field 503 may be prepared for each of a downlink (a link from the AP 100 to the STA 101) and an uplink (a link from the STA 101 to the AP 100).

The TID-To-Link Mapping Element includes an Element ID field 511, a Length Field 512, and an Element ID Extension field 513. The TID-To-Link Mapping Element also includes a TID-To-Link Mapping Control field 514 and a Link Mapping Of TID field 515. The Element ID field 511 and the Element ID Extension field 513 store values indicating the type of this element. In this embodiment, 255 and 109 are stored, as values indicating that this element is a TID-To-Link Mapping Element, in the Element ID field 511 and the Element ID Extension field 513, respectively. The Length Field 512 stores a value indicating the length of this element.

The TID-To-Link Mapping Control field 514 includes a Direction field 521 and a Default Link Mapping field 522. Furthermore, the TID-To-Link Mapping Control field 514 includes a Link Mapping Size field 523 and a Link Mapping Presence Indicator field 524.

The Direction field 521 stores a value indicating a communication direction (at least one of the downlink and the uplink). This field stores "0" to indicate only downlink communication, "1" to indicate only uplink communication, and "2" to indicate both downlink communication and uplink communication. The Default Link Mapping field 522 stores a value indicating whether to set the TID-To-Link Mapping in a default state. This field stores "1" when the default state is used. In this example, the default state is a state in which all TIDs are assigned to all the established links to allow any communication. The field stores "0" when another state is used. For example, when a state in which a given link is not used for communication is set, the field stores "0". For example, when link 2 is set in the Disable state, the field stores "0". The Link Mapping Size field 523 stores a value indicating the length of the Link Mapping Of TID field 515 arranged after the TID-To-Link Mapping Control field 514. For example, when a value "1" is stored, it is indicated that the length of the Link Mapping Of TID field 515 is 1 octet. When a value "0" is stored, it is indicated that the length of the Link Mapping Of TID field 515 is 2 octets. The Link Mapping Presence Indicator field 524 is a bitmap indicating whether the Link Mapping Of TID field 515 exists for each TID. When, for example, the first bit corresponds to the TID = 0 and is set to "1", it is indicated that there exists a corresponding Link Mapping Of TID 0 field 515-0. Note that if "1" is set in the Default Link Mapping field 522, the Link Mapping Of TID field 515 is omitted. In this embodiment, for example, since link 2 is set in the Disable state, "0" is set in the Default Link Mapping field 522. Therefore, "1" is set in all bits of the bitmap so that there exists the Link Mapping Presence Indicator field 524 and link 2 is set in the Disable state with respect to all the TIDs.

The Link Mapping Of TID field 515 is a field prepared for each TID, and there exist up to eight Link Mapping Of TID fields 515. A Link Mapping Of TID n field 515-n concerning the nth (0 ≤ n ≤ 7) TID is formed by a bit string that designates a link in which communication of traffic of the TID is permitted. When in the bit string, for example, each bit corresponds to a Link ID and the bit corresponding to a specific Link ID is set to "1", it is indicated that communication of traffic of the TID is permitted in the link. When, for example, "101" is set in a Link Mapping Of TID 1 field 515-1, it is indicated that transmission of traffic of TID = 1 is permitted in links of the Link IDs = 1 and 3. On the other hand, in this case, transmission of traffic of the TID = 1 is not permitted in a link of the Link ID = 2. For example, for all the TIDs, the bit corresponding to the Link ID = 2 is set to "0", and the link of the Link ID = 2 can be set in the Disable state.

Referring to FIG. 4, the AP 100 requests the STA 101 to set, for example, link 2 in the Disable state using the above-described frame structure.

Upon receiving the request from the AP 100, the STA 101 responds with approval or rejection of the request using a TID-To-Link Mapping Response frame (F402). The structure of this frame will also be described with reference to FIG. 5. Note that a description of the same points as in the TID-To-Link Mapping Request frame will be omitted.

In the TID-To-Link Mapping Response frame, a Protected EHT Action field 502 stores a value "1". A Status Code field (not shown) is inserted between a Dialog Token field and a TID-To-Link Mapping field 503. The Status Code field indicates whether contents requested in the TID-To-Link Mapping Request frame are approved. If the Status Code field stores a value "0", it is indicated that the request of the AP 100 is approved. On the other hand, if the Status Code field stores a value "133", it is indicated that the request of the AP 100 is rejected. If the Status Code field stores a value "134", it is indicated that the STA 101 presents contents different from those in the request from the AP 100. If the Status Code field stores a value "134", the TID-To-Link Mapping field 503 is inserted. Then, similar to the case of the above-described request from the AP 100, the AP 100 is notified of a proposal from the STA 101 by including information for designating a link in which transmission of traffic of each TID should be permitted. On the other hand, if the Status Code field stores no value "134", the TID-To-Link Mapping field 503 is omitted.

If the AP 100 and the STA 101 confirm with each other that link 2 will be set in the Disable state, they stop power supply to the antenna assigned to link 2 (F403 and F404). Thus, while maintaining link 2, it is possible to suppress power consumption for communication in link 2.

After that, assume that, for example, a large amount of transmission data is generated in the STA 101 and a link needs to be added. In this case, the STA 101 transmits an unsolicited TID-To-Link Mapping Response frame to the AP 100 in link 1 (F405). That is, in a state in which no TID-To-Link Mapping Request frame is received, the STA 101 transmits a TID-To-Link Mapping Response frame. The transmitted frame has the format of the TID-To-Link Mapping Response frame in which a value "134" is stored in the above-described Status Code field. This frame includes, for example, the TID-To-Link Mapping field 503 indicating that transmission in link 2 should be permitted with respect to at least one TID. Upon receiving the unsolicited TID-To-Link Mapping Response frame, the AP 100 transmits a TID-To-Link Mapping Request frame in link 1 (F406). The transmitted TID-To-Link Mapping Request frame has the above-described structure. This frame can include, for example, the same TID-To-Link Mapping field 503 as in the unsolicited TID-To-Link Mapping Response frame transmitted by the STA 101. Note that the AP 100 may include, in this frame, the TID-To-Link Mapping field 503 different from that in the unsolicited TID-To-Link Mapping Response frame. That is, the AP 100 need not approve the proposal from the STA 101 and may transmit another proposal to the STA 101. Note that in F405 and F406, by storing a value "1" in the Default Link Mapping field 522, it may be indicated that transmission of traffic of all the TIDs is permitted in all the links. Upon receiving the TID-To-Link Mapping Request frame, the STA 101 transmits the TID-To-Link Mapping Response frame as a response (F407). As an example, if the AP 100 and the STA 101 confirm with each other that traffic of at least one TID will be transmitted in link 2, they sets link 2 in the Enable state and restarts power supply to the antenna assigned to link 2.

As described above, in this processing example, by designating a link in which transmission of traffic of each TID is permitted, the state of a specific link is transitioned between the Disable state and the Enable state. This can stop communication in the link while maintaining the link, and restart communication using the link without performing new setting processing.

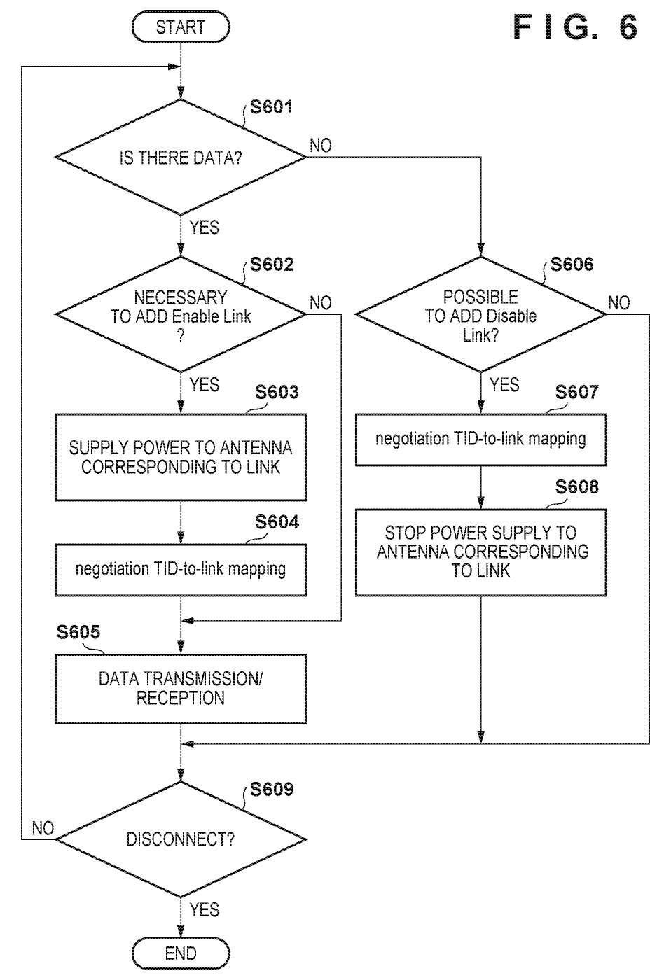

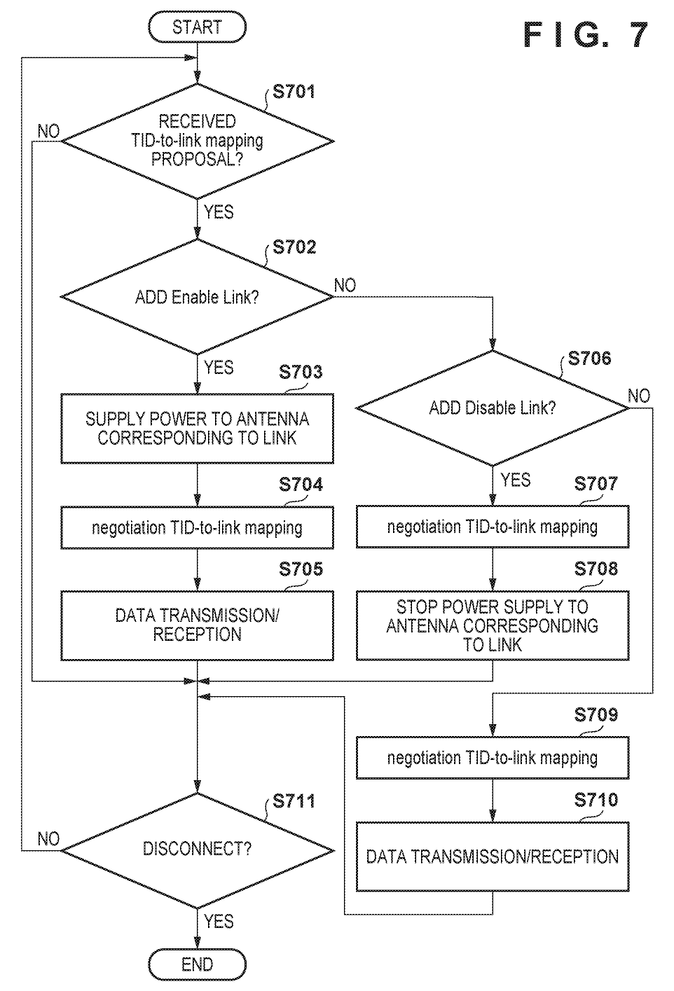

Subsequently, an example of the procedure of processing at the time of transmission/reception of the TID-To-Link Mapping Request frame and the TID-To-Link Mapping Response frame will be described. FIG. 6 shows an example of the procedure of the processing of the communication apparatus on the request side of transition between the Enable state and the Disable state of the specific link. FIG. 7 shows an example of the procedure of the processing of the communication apparatus on the request reception side. Note that the AP 100 and the STA 101 are configured to execute both of these processes. That is, each of the AP 100 and the STA 101 can operate as both the request side and the request reception side of transition between the Enable state and the Disable state of the specific link. Therefore, the subject that performs the processing will be referred to as the "communication apparatus" that can be either the AP 100 or the STA 101 hereinafter.

Referring to FIG. 6, first, the communication apparatus confirms whether there is data to be communicated (step S601). If there is data to be communicated (YES in step S601), the communication apparatus advances the process to step S602. If there is no data to be communicated (NO in step S601), the communication apparatus advances the process to step S606. Note that if it is assumed that data to be communicated, which is more than a predetermined threshold, is generated, the communication apparatus determines YES in step S601, and if it is not assumed that data to be communicated, which is more than the predetermined threshold, is generated, the communication apparatus determines NO in step S601. Alternatively, if a communication frequency is equal to or higher than a predetermined threshold, the communication apparatus may determine YES in step S601, and if the communication frequency is lower than the threshold, the communication apparatus may determine NO in step S601. Alternatively, if the remaining battery amount of the self-apparatus is smaller than a threshold, the communication apparatus may determine NO in step S601, and if the remaining battery amount of the self-apparatus is equal to or larger than the threshold, the communication apparatus may determine YES in step S601. Alternatively, if the received radio field intensity or signal-to-noise ratio (SNR) in a given link is lower than a threshold, the communication apparatus may determine NO in step S601, and if the received radio field intensity or SNR is equal to or higher than the threshold, the communication apparatus may determine YES in step S601. Furthermore, if, for example, the STA 101 is running a specific application, the communication apparatus may determine YES in step S601, and if such specific application is not running, the communication apparatus may determine NO in step S601. If, for example, a communication boost mode is enabled by a setting via a user interface (UI), the communication apparatus may determine YES in step S601, and if the mode is disabled, the communication apparatus may determine NO in step S601. As described above, depending on whether various conditions are satisfied in step S601, the communication apparatus can advance the process to step S602 or S606.

In step S602, the communication apparatus determines whether an enable link that is set in a communicable state needs to be added or can be added. If an enable link need not be added or cannot be added (NO in step S602), the communication apparatus advances the process to step S605. If, for example, there is a link already established and set in the Disable state, the communication apparatus can determine that an enable link can be added. If an enable link needs to be added and can be added (YES in step S602), the communication apparatus supplies power to an antenna and an RF circuit corresponding to the link in the Disable state (step S603). This allows the communication apparatus to transmit/receive data using the link. After that, the communication apparatus performs negotiation TID-To-Link Mapping processing to change the link in the Disable state to the Enable state (step S604). This corresponds to the processing of F405 to F407 of FIG. 4.

If the self-apparatus is the AP 100, the communication apparatus transmits a TID-To-Link Mapping Request frame to the STA 101. Then, the communication apparatus receives a TID-To-Link Mapping Response frame, and determines whether the STA 101 has approved the change of the TID-To-Link Mapping. Note that if the change has not been approved, the communication apparatus can change the TID-To-Link Mapping configuration and retransmit the TID-To-Link Mapping Request frame to the STA 101. Furthermore, if the change has not been approved, the communication apparatus may determine not to change the current state, and stop power supply to the antenna, which has been started in step S603. With this processing, the change of the TID-To-Link Mapping is approved, and negotiation in step S604 is complete.

If the self-apparatus is the STA 101, the communication apparatus transmits an unsolicited TID-To-Link Mapping Response frame to the AP 100. After that, the communication apparatus receives a TID-To-Link Mapping Request frame from the AP 100. Then, if the TID-To-Link Mapping configuration designated in the TID-To-Link Mapping Request frame is the same as that requested by the self-apparatus, the communication apparatus can determine that the request has been approved. If the request has been approved or the TID-To-Link Mapping configuration designated by the AP 100 can be accepted, the communication apparatus transmits, to the AP 100, a TID-To-Link Mapping Response frame for approving contents. Note that if the TID-To-Link Mapping configuration designated by the AP 100 is rejected, the communication apparatus can transmit, to the AP 100, a TID-To-Link Mapping Response frame for proposing a permissible configuration. In this case, the Status Code field set with a value "134" and the TID-To-Link Mapping configuration can be included in the TID-To-Link Mapping Response frame. If the current state is maintained, the communication apparatus may transmit, to the AP 100, a TID-To-Link Mapping Response frame indicating rejection of the TID-To-Link Mapping configuration designated by the AP 100. In this case, the Status Code field set with a value "133" can be included in the TID-To-Link Mapping Response frame. In an example, if the communication apparatus proposes the TID-To-Link Mapping a predetermined number of times (for example, five times), and the proposal is not yet approved by the partner apparatus, the communication apparatus may disconnect the connection from the partner apparatus. Alternatively, if the proposal is continuously rejected the predetermined number of times, the communication apparatus may decide to continue communication in the current state.

Note that in the above-described example, after the start of power supply to the antenna of the link to be added (step S603), negotiation for transition to the Enable state is performed (step S604), but the present disclosure is not limited to this. That is, steps S603 and S604 may be performed in a reverse order or performed simultaneously. After that, the communication apparatus executes data communication with the partner apparatus (step S605). After that, the communication apparatus determines whether to disconnect the connection from the partner apparatus (step S609). If it is determined to disconnect the connection (YES in step S609), the communication apparatus ends the processing. If it is determined not to disconnect the connection (NO in step S609), the communication apparatus returns the process to step S601.

In step S606, the communication apparatus determines whether to add a link in the Disable state. If the communication apparatus has already set some links in the Disable state and only one link is in the Enable state, the communication apparatus cannot set the link in the Disable state, and thus determines not to add a link in the Disable state (NO in step S606). In this case, the communication apparatus advances the process to step S609. If the communication apparatus determines to add a link in the Disable state (YES in step S606), it executes negotiation TID-To-Link Mapping processing (step S607). This processing corresponds to the processing of F401 and F402 in FIG. 4. In this case, the communication apparatus designates a TID-To-Link Mapping that does not permit transmission of traffic of all the TIDs in some links, thereby performing negotiation to set the links in the Disable state. Note that in a connection form in which the AP 100 is an NSTR AP MLD and the primary link is decided, the negotiation is executed so as not to set the primary link in the Disable state. Note that among the plurality of links, a link that operates in a channel in which a beacon is transmitted/received is the primary link, and a link that operates in a channel in which no beacon is transmitted/received is the non-primary link. The communication apparatus stops power supply to the corresponding antenna and RF circuit with respect to the link decided to be set in the Disable state in the negotiation TID-To-Link Mapping processing (step S607) (step S608), and shifts to a power saving mode. After that, the communication apparatus advances the process to step S609. The processing in step S609 is as described above and a repetitive description thereof will be omitted.

Referring to FIG. 7, while the link established with the partner apparatus is not disconnected (NO in step S711), the communication apparatus stands by for reception of a TID-To-Link Mapping proposal from the partner apparatus (step S701). Upon receiving the proposal (YES in step S701), the communication apparatus confirms whether the proposal is a request to add a link in the Enable state (step S702). If it is determined that the proposal is a request to add a link in the Enable state (YES in step S702), the communication apparatus restarts power supply to the antenna and the RF circuit corresponding to the link to be set in the Enable state (step S703). Then, the communication apparatus continues the negotiation TID-To-Link Mapping procedure started upon receiving the proposal in step S701 (step S704). This procedure corresponds to F405 to F407 of FIG. 4. In accordance with the TID for which transmission in the link set in the Enable state is permitted based on the TID-To-Link Mapping, the communication apparatus transmits/receives traffic of the TID in the link (step S705). Note that power supply to the antenna and the like (step S703) may be executed after the negotiation (step S704). For example, the communication apparatus can reject the proposal in a case where a link different from the link requested to be set in the Enable state should be set in the Enable state. In this case, if it is decided to set another link in the Enable state by the negotiation in step S704, the communication apparatus can restart power supply to the antenna and the like corresponding to the link. Alternatively, if it is decided to maintain the current state by the negotiation in step S704, the communication apparatus does not execute the processing in step S703.

On the other hand, if it is determined that the proposal received in step S701 is not a request to add a link in the Enable state (NO in step S702), the communication apparatus confirms whether the proposal is a request to add a link in the Disable state (step S706). If it is determined that the proposal is a request to add a link in the Disable state (YES in step S706), the communication apparatus continues the negotiation TID-To-Link Mapping procedure (step S707). The procedure corresponds to F401 and F402 of FIG. 4. When a link to be set in the Disable state is confirmed by the negotiation TID-To-Link Mapping procedure, the communication apparatus stops power supply to the antenna and the RF circuit corresponding to the link (step S708). This allows the communication apparatus to suppress power consumption. Note that if the proposal is not a request to add a link in the Enable state or a link in the Disable state, the communication apparatus continues the negotiation TID-To-Link Mapping procedure (step S709). Then, in accordance with the TID for which transmission in the link in the Enable state is permitted based on the TID-To-Link Mapping, the communication apparatus transmits/receives traffic of the TID in the link (step S710).

Note that the communication apparatus continuously executes the above-described processing until the connection with the partner apparatus is disconnected (step S711).

As described above, the communication apparatus switches the state of the link between the Enable state and the Disable state by dynamically updating the TID-To-Link Mapping. Thus, by making a setting not to use the established link while maintaining the link, power saving of the communication apparatus is achieved, and a new complicated procedure such as key exchange need not be performed to restart the use of the link. In this procedure, not only the STA 101 but also the AP 100 need not supply power to the antenna and the RF circuit corresponding to the link in the Disable state and need not stand by for reception of a signal, thereby making it possible to suppress power consumption.

Note that FIG. 4 shows an example in which a procedure for adding a disable link starts upon transmission of a TID-To-Link Mapping Request frame from the AP 100 but the present disclosure is not limited to this. For example, when the STA 101 transmits an unsolicited TID-To-Link Mapping Response frame, a procedure for adding a disable link may be started. Furthermore, an example in which a procedure for adding a link in the Enable state starts upon transmission of an unsolicited TID-To-Link Mapping Response frame from the STA 101 has been explained above, but the present disclosure is not limited to this. For example, a procedure for adding a link in the Enable state may be started when the AP 100 transmits a TID-To-Link Mapping Request frame.

### Processing Example 2

In this processing example, when establishing connection between the AP 100 and the STA 101, negotiation of a link to be set in the Disable state is performed using the TID-To-Link Mapping. The communication apparatus can suppress power consumption by supplying no power to the antenna and the RF circuit in a link that is set in the Disable state at the time of connection.

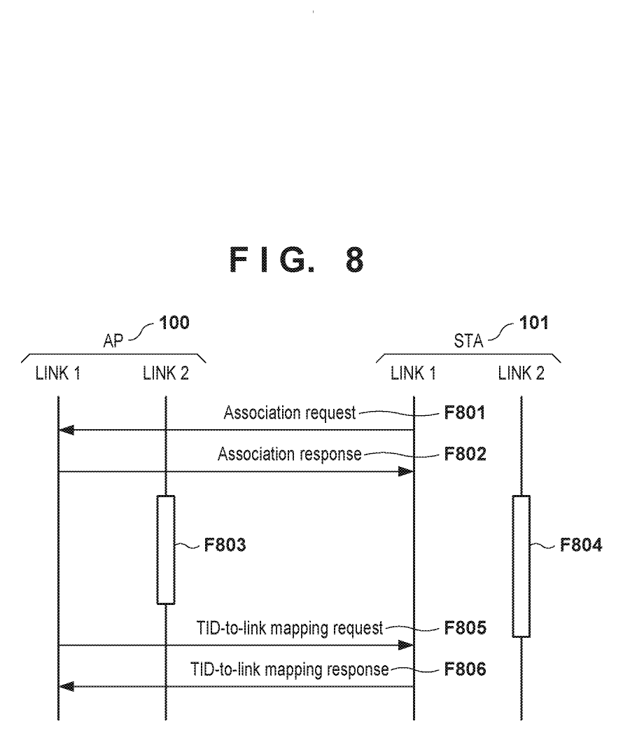

FIG. 8 shows an example of the procedure of communication according to this processing example. In this processing example, an Association Request frame to be transmitted by the STA 101 to establish connection is provided with a TID-To-Link Mapping Element. The STA 101 designates a proposed TID-To-Link Mapping in the TID-To-Link Mapping Element, and transmits the frame to the AP 100 (F801). Then, the AP 100 transmits, to the STA 101, an Association Response frame including approval or rejection of the TID-To-Link Mapping or another proposal different from that of the STA 101 (F802).

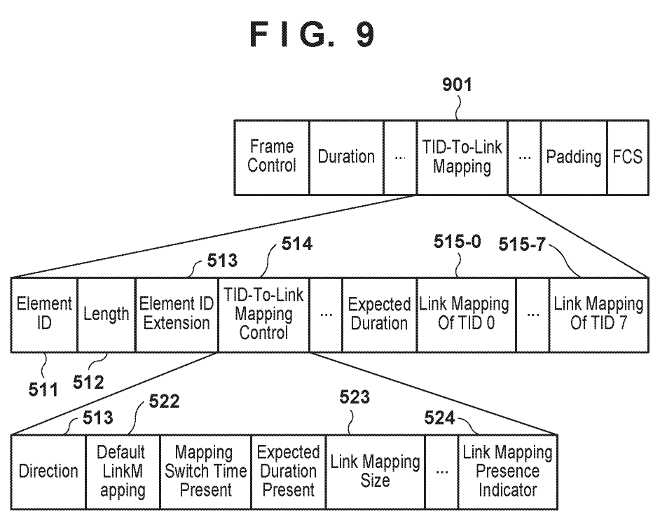

The transmitted Association Request frame and Association Response frame have, for example, a structure including a TID-To-Link Mapping Element 901, as shown in FIG. 9. The contents of the TID-To-Link Mapping Element 901 are the same as those described with reference to FIG. 5 and repetitive description thereof will be omitted. In this processing example, for example, to set link 2 in the Disable state, the STA 101 proposes, to the AP 100, a TID-To-Link Mapping such that transmission/reception of traffic of all the TIDs is not permitted in link 2. If the AP 100 approves the proposal, it sets the TID-To-Link Mapping in accordance with the proposal. For example, the AP 100 sets link 2 in the Disable state in accordance with the proposal of the STA 101. Then, the AP 100 and the STA 101 stop power supply to the antenna and the RF circuit corresponding to link 2 in the Disable state (F803 and F804).

Note that when restarting the use of the link in the Disable state, the AP 100 and the STA 101 perform the same processing as in the procedure described in processing example 1. For example, the AP 100 can transmit a TID-To-Link Mapping Request frame to the STA 101 in link 1 (F805). Then, in response to this, the STA 101 returns a TID-To-Link Mapping Response frame to the AP 100 (F806). This restarts communication in link 2 that was in the Disable state. Note that FIG. 8 shows an example in which the AP 100 transmits the TID-To-Link Mapping Request frame to start a negotiation TID-To-Link Mapping procedure, but the present disclosure is not limited to this. That is, similar to FIG. 4, this procedure may be started when the STA 101 transmits an unsolicited TID-To-Link Mapping Response frame.

Note that by adding a TID-To-Link Mapping Element to the Association Response frame transmitted by the AP 100, a link that is set in the Disable state immediately after connection may be decided. An example in which TID-To-Link Mapping setting is performed using the Association Request frame and the Association Response frame has been described, but the present disclosure is not limited to this. For example, the setting may be performed by a ReAssociation Request frame and a ReAssociation Response frame that are used for reconnection between the AP 100 and the STA 101.

In this manner, when establishing a plurality of links, the AP 100 and the STA 101 can decide a link that is set in the Disable state immediately after connection, thereby controlling a reception standby state. Thus, the AP 100 and the STA 101 can keep the plurality of links available any time, and can set the link in the Disable state in a case where the link will not be used immediately after establishment of connection, thereby preventing power consumption from increasing.

### Processing Example 3

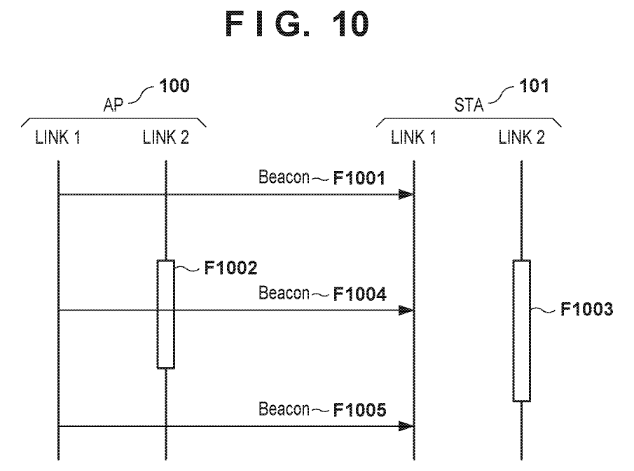

In this processing example, a TID-To-Link Mapping Element is added to a Beacon frame or a Probe Response frame transmitted by the AP 100, and all the STAs connectable to the AP 100 are notified of a link to be set in the Disable state. Note that "link" here corresponds to a network (frequency channel) in which the link is established. FIG. 10 shows an example of the procedure of communication according to this processing example. The AP 100 transmits a Beacon frame in link 1. As shown in FIG. 9, the transmitted Beacon frame includes the TID-To-Link Mapping Element. The AP 100 indicates in the TID-To-Link Mapping Element of the Beacon frame that transmission of traffic of all the TIDs is not permitted in link 2 (F1001 and F1004). This indicates that link 2 is set in the Disable state in the AP 100. The AP 100 stops power supply to the corresponding antenna and RF circuit with respect to link 2 set in the Disable state (F1002). The STA 101 confirms, by decoding the received Beacon frame, that link 2 is in the Disable state, and supplies no power to the antenna and the RF circuit corresponding to link 2 (F1003). Thus, the AP 100 and the STA 101 need not transmit signals unnecessarily or stand by for reception of the signals, thereby suppressing power consumption.

After that, assume that the AP 100 decides to set, to the Enable state, link 2 that has been set in the Disable state. In this case, the AP 100 restarts power supply to the antenna and the RF circuit corresponding to link 2. Furthermore, the AP 100 transmits the Beacon frame by including the TID-To-Link Mapping Element that has been changed to indicate that transmission of traffic of at least one TID is permitted in link 2 (F1005). This sets link 2 in the Enable state. Upon receiving the Beacon frame, the STA 101 confirms the updated TID-To-Link Mapping Element, and restarts power supply to the antenna and the RF circuit corresponding to link 2.

As described above, the AP 100 can dynamically switch the state of each of some of the plurality of links between the Enable state and the Disable state, and the STA 101 can specify the state by the received Beacon frame. Then, by stopping power supply to the antenna and the RF circuit corresponding to the link in the Disable state, it is possible to suppress power consumption of the AP 100 and the STA 101.

Note that if the AP 100 receives a Probe Request frame from the STA 101, it can notify the STA 101 of the state of each link by a Probe Response frame as a response to the Probe Request frame. That is, by transmitting the Probe Response frame by including the TID-To-Link Mapping Element, it can be indicated whether each link that can be established is in the Disable state or the Enable state. This also can suppress power consumption of the AP 100 and the STA 101.

Note that processing examples 1 to 3 described above can arbitrarily be used in combination. For example, with respect to the link for which it is notified that the link is in the Disable state, as in processing example 3, the AP 100 may set the link in the Enable state with only the specific STA 101. In this case, using, for example, processing example 1, the AP 100 can transmit the TID-To-Link Mapping to the STA 101 by unicast. In this case as well, the AP 100 can suppress power consumption by setting link 2 in the Disable state with all the STAs except when link 2 is used for communication with the specific STA 101. In addition, if the STA 101 uses link 2 only during a specific period, the STA 101 can suppress power consumption by stopping power supply to the antenna and the like corresponding to link 2 during the remaining period.

The above-described embodiment has explained an example of switching each link between the Enable state and the Disable state by using the TID-To-Link Mapping. However, this is merely an example, and another method may be used. For example, instead of setting the specific link in the Disable state while maintaining it, the specific link may be deleted. In this case, when restarting the use of the specific link, a procedure for adding the link is performed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus capable of executing communication complying with an IEEE 802.11 series standard by establishing a plurality of radio links with a partner apparatus, comprising:
a communication unit configured to communicate a radio frame including information for requesting not to permit transmission of all types of traffic in some radio links among the plurality of radio links, with the partner apparatus in other radio links among the plurality of radio links; and
a control unit configured to control, based on the radio frame, to set an incommunicable state while maintaining the some radio links by not permitting transmission of all the types of traffic in the some radio links.

2. The communication apparatus according to claim 1, wherein
in a case where the communication unit transmits the radio frame to the partner apparatus, and receives, from the partner apparatus, a response indicating that it is approved that transmission of all the types of traffic is not permitted in the some radio links, the control unit controls to set the incommunicable state while maintaining the some radio links.

3. The communication apparatus according to claim 1, wherein
in a case where the communication unit transmits a radio frame including a first request indicating that transmission of all the types of traffic is not permitted in some radio links among the plurality of radio links, and the partner apparatus rejects the first request, the communication unit transmits, to the partner apparatus, a radio frame including a second request indicating that transmission of all the types of traffic is not permitted in some other radio links different from the some radio links among the plurality of radio links.

4. The communication apparatus according to claim 1, further comprising a determination unit configured to determine, in a case where the communication unit transmits a radio link including a first request indicating that transmission of all the types of traffic is not permitted in some radio links among the plurality of radio links, and receives, from the partner apparatus, a radio link including a second request indicating that transmission of all the types of traffic is not permitted in some other radio links different from the some radio links among the plurality of radio links, whether to approve the second request,
wherein in a case where the determination unit approves the second request, the control unit controls, in accordance with the second request, to set the incommunicable state while maintaining the some other radio links.

5. The communication apparatus according to claim 4, wherein
in a case where the determination unit does not approve the second request, the communication unit transmits, to the partner apparatus, a radio frame including a third request indicating that transmission of all the types of traffic is not permitted in a radio link different from the second request.

6. The communication apparatus according to claim 1, wherein
under a condition that at least one of a case where there is no data to be communicated, a case where an amount of data to be communicated is smaller than a threshold, a case where a communication frequency is lower than a threshold, and a case where a remaining battery amount of the communication apparatus is smaller than a threshold is satisfied, the communication unit transmits, to the partner apparatus, the radio frame including the information for requesting not to permit transmission of all the types of traffic in the some radio links among the plurality of radio links.

7. The communication apparatus according to claim 1, further comprising a determination unit configured to determine, in a case where the communication unit receives, from the partner apparatus, a radio frame including a first request indicating that transmission of all the types of traffic is not permitted in some radio links among the plurality of radio links, whether to approve the first request.

8. The communication apparatus according to claim 7, wherein
in a case where the determination unit determines to approve the first request, the communication unit transmits a response indicating the approval to the partner apparatus, and
based on the transmission of the response, the control unit controls to set the incommunicable state while maintaining the some radio links indicated by the first request.

9. The communication apparatus according to claim 7, wherein
in a case where the determination unit determines not to approve the first request, the communication unit transmits, to the partner apparatus, a response including a second request indicating that transmission of all the types of traffic is not permitted in some other radio links different from the some radio links among the plurality of radio links.

10. The communication apparatus according to claim 7, wherein
in a case where the determination unit determines not to approve the first request, the communication unit transmits, to the partner apparatus, a response indicating that the first request is not approved.

11. The communication apparatus according to claim 1, wherein
the communication unit communicates, with the partner apparatus, a second radio frame including information for requesting to set, to a state in which transmission of at least one type of traffic is permitted, the some radio links in the state in which transmission of all the types of traffic is not permitted.

12. The communication apparatus according to claim 1, wherein
the radio frame is a TID-To-Link Mapping Request frame.

13. The communication apparatus according to claim 8, wherein
the response is a TID-To-Link Mapping Response frame.

14. The communication apparatus according to claim 1, wherein
the radio frame is one of a Beacon frame and a Probe Response frame.

15. The communication apparatus according to claim 1, wherein
the radio frame is an Association Request frame.

16. The communication apparatus according to claim 8, wherein
the response is an Association Response frame.

17. A control method executed by a communication apparatus capable of executing communication complying with an IEEE 802.11 series standard by establishing a plurality of radio links with a partner apparatus, the control method comprising:
communicating a radio frame including information for requesting not to permit transmission of all types of traffic in some radio links among the plurality of radio links, with the partner apparatus in other radio links among the plurality of radio links; and
controlling, based on the radio frame, to set an incommunicable state while maintaining the some radio links by not permitting transmission of all the types of traffic in the some radio links.

18. A non-transitory computer-readable storage medium that stores a program for causing a computer included in a communication apparatus capable of executing communication complying with an IEEE 802.11 series standard by establishing a plurality of radio links with a partner apparatus to:
communicate a radio frame including information for requesting not to permit transmission of all types of traffic in some radio links among the plurality of radio links, with the partner apparatus in other radio links among the plurality of radio links; and
control, based on the radio frame, to set an incommunicable state while maintaining the some radio links by not permitting transmission of all the types of traffic in the some radio links.
